(19) United States
(12) Patent Application Publication
(10) Pub. No.: US 2023/0153469 A1
(43) Pub. Date: May 18, 2023

(54) APPARATUS FOR MANAGING EVIDENCE BASED ON PACKAGING USING LINKAGE HIERARCHICAL CHAIN IDENTIFIER AND EVIDENCE WITH CASE PROCESS, AND METHOD USING THE SAME

(71) Applicant: ELECTRONICS AND TELECOMMUNICATIONS RESEARCH INSTITUTE, Daejeon (KR)

(72) Inventor: Byung-Gil LEE, Daejeon (KR)

(73) Assignee: ELECTRONICS AND TELECOMMUNICATIONS RESEARCH INSTITUTE, Daejeon (KR)

(21) Appl. No.: 17/989,431

(22) Filed: Nov. 17, 2022

(30) Foreign Application Priority Data
Nov. 18, 2021 (KR) 10-2021-0159211

(51) Int. Cl. G06F 21/64; G06Q 50/18

(52) U.S. Cl. CPC G06F 21/64; G06Q 50/18

(57) ABSTRACT

Disclosed herein are an apparatus for managing evidence based on packaging using a linkage hierarchical chain identifier and a method using the apparatus. The method for managing evidence includes collecting evidential data for an incident or an accident, generating an evidence package for each phase of an evidence management procedure based on a linkage hierarchical chain identifier generated in consideration of collection of the evidential data and an evidence-processing flow, and generating an integrated evidence package, including details on successive transfers according to the evidence management procedure, based on the evidence package for each phase of the evidence management procedure.

### CROSS REFERENCE TO RELATED APPLICATION

This application claims the benefit of Korean Patent Application No. 10-2021-0159211, filed Nov. 18, 2021, which is hereby incorporated by reference in its entirety into this application.

### BACKGROUND OF THE INVENTION

### 1. Technical Field

The present disclosure relates generally to technology for managing evidence based on packaging using a linkage hierarchical chain identifier, and more particularly to technology for managing evidence using a packaging method capable of easily detecting the association between pieces of evidence using a linkage hierarchical chain identifier, that is, an identifier of a multi-chain connection method, through which evidence collection and an evidence-processing flow for digital forensics of various accidents, such as marine collisions, and the like, are capable of being identified.

### 2. Description of the Related Art

Generally, investigative and judicial institutions perform an evidence-processing procedure according to the order illustrated in FIG. 1. However, evidential data may be damaged in the procedure illustrated in FIG. 1, and in order to prevent this problem, an integrity principle, a justification principle, and an evidence preservation principle are presented.

First, the integrity principle is the principle that, when evidence is processed, the original data should not be altered by processing. Also, the justification principle is the principle that, when the original data is directly handled, there should be justification. The evidence preservation principle is the principle that the method and procedure used for processing evidence should be recorded and stored such that a third party is able to examine the same.

It is cumbersome to follow the procedure in compliance with these principles, but these principles have to be observed in order to have legal effects. Also, it may be very difficult for investigators to check whether these principles are observed each time they conduct investigation and process evidence.

Therefore, new technology for systematically managing evidence in compliance with these principles is required.

### DOCUMENTS OF RELATED ART

(Patent Document 1) Korean Patent Application Publication No. 10-2020-0129879, published on Nov. 18, 2020 and titled “System for managing legal evidence”.

### SUMMARY OF THE INVENTION

An object of the present disclosure is to provide technology for managing evidence collected from each phase and each element while complying with regulations such that evidential data, which is digitized for validation of evidence collected in various incidents and accidents, is prevented from losing admissibility.

Another object of the present disclosure is to prevent a problem in which the legal validity of evidential data is lost in the processes of collecting, analyzing, and submitting the evidential data.

A further object of the present disclosure is to obtain evidence and to organize collected evidence information and additional information in a package form to be provided each time evidence is obtained, thereby proving that digital evidence is managed without any alteration to the original state, as it is first collected.

Yet another object of the present disclosure is to provide an evidence packaging method using an evidence collection identifier and an evidence-processing identifier that are linked to each other in order to easily detect how evidence is collected and managed and whether additional evidence is collected and in order to manage the evidence.

Still another object of the present disclosure is to provide a system for analyzing evidential data extracted from incidents and accidents and for forming and managing an evidence package for digital data to be submitted to a court after various processes, such as evidence collection, transportation, and analysis, when a briefing on the evidential data is provided.

In order to accomplish the above objects, a method for managing evidence according to the present disclosure includes collecting evidential data for an incident or an accident, generating an evidence package for each phase of an evidence management procedure based on a linkage hierarchical chain identifier generated in consideration of collection of the evidential data and an evidence-processing flow, and generating an integrated evidence package, including details on successive transfers according to the evidence management procedure, based on the evidence package for each phase of the evidence management procedure.

Here, the linkage hierarchical chain identifier may be generated by linking an evidence collection identifier for identifying the collection of the evidential data and an evidence-processing identifier for identifying the evidence-processing flow.

Here, the evidence management procedure performed using the evidence-processing identifier may correspond to a sequence of evidence collection, evidence sealing, evidence transportation, device analysis, incident analysis, and evidence integration.

Here, the evidence package may include the linkage hierarchical chain identifier, additional evidence and collected evidence data obtained by a task processed for each phase of the evidence management procedure, a hash value, information about a person who processes the task, log information, and additional information.

Here, the linkage hierarchical chain identifier may be classified for each incident by being matched to an incident management identifier corresponding to the incident or the accident.

Here, the evidence collection identifier may be generated in a hierarchical structure from a broad to a narrow range in consideration of a range within which evidence is collected.

Here, the range within which evidence is collected may be classified in consideration of the source of a device from which the evidence is collected, the device from which the evidence is collected, and the type of the evidence.

Here, integrity verification may be performed based on the hash value in phases performed after the evidence package is generated in the evidence management procedure.

Here, the method may further include, based on the integrated evidence package, generating a report capable of being submitted as legal evidence for the incident or the accident.

Here, the collected evidence data may include additional metadata and image data collected based on the evidential data.

Also, an apparatus for managing evidence according to an embodiment of the present disclosure includes a processor for collecting evidential data for an incident or an accident, generating an evidence package for each phase of an evidence management procedure based on a linkage hierarchical chain identifier generated in consideration of collection of the evidential data and an evidence-processing flow, and generating an integrated evidence package, which includes details on successive transfers according to the evidence management procedure, based on the evidence package for each phase of the evidence management procedure; and memory for storing the evidence package for each phase of the evidence management procedure and the integrated evidence package.

Here, the linkage hierarchical chain identifier may be generated by linking an evidence collection identifier for identifying the collection of the evidential data and an evidence-processing identifier for identifying the evidence-processing flow.

Here, the evidence management procedure performed using the evidence-processing identifier may correspond to a sequence of evidence collection, evidence sealing, evidence transportation, device analysis, incident analysis, and evidence integration.

Here, the evidence package may include the linkage hierarchical chain identifier, additional evidence and collected evidence data obtained by a task processed for each phase of the evidence management procedure, a hash value, information about a person who processes the task, log information, and additional information.

Here, the linkage hierarchical chain identifier may be classified for each incident by being matched to an incident management identifier corresponding to the incident or the accident.

Here, the evidence collection identifier may be generated in a hierarchical structure from a broad to a narrow range in consideration of a range within which evidence is collected.

Here, the range within which evidence is collected may be classified in consideration of the source of a device from which the evidence is collected, the device from which the evidence is collected, and the type of the evidence.

Here, the processor may perform integrity verification based on the hash value in phases performed after the evidence package is generated in the evidence management procedure.

Here, the processor may generate a report capable of being submitted as legal evidence for the incident or the accident based on the integrated evidence package.

Here, the collected evidence data may include additional metadata and image data collected based on the evidential data.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a view illustrating an example of a general forensic procedure (from investigation to a judicial institution);

FIG. 2 is a flowchart illustrating a method for managing evidence based on packaging using a linkage hierarchical chain identifier according to an embodiment of the present disclosure;

FIG. 3 is a view illustrating an example of a procedure and content for phased forensics according to the present disclosure;

FIGS. 4A and 4B are views illustrating in detail a process of generating an evidence package for each phase of an evidence management procedure and generating an integrated evidence package based thereon according to the present disclosure;

FIG. 5 is a view illustrating an example of an identifier system according to the present disclosure;

FIGS. 6A, 6B and 7 are views illustrating an example of a maritime accident evidence package management program according to the present disclosure;

FIG. 8 is a view illustrating an example of a process of submitting an integrated evidence package as legal evidence according to the present disclosure;

FIG. 9 is a flowchart illustrating in detail a process of generating an integrated evidence package and submitting the same to a court according to the present disclosure;

FIG. 10 is a block diagram illustrating an example of a process of collecting and processing evidence according to the present disclosure; and

FIG. 11 is a view illustrating an example of an apparatus for managing evidence based on packaging using a linkage hierarchical chain identifier according to the present disclosure.

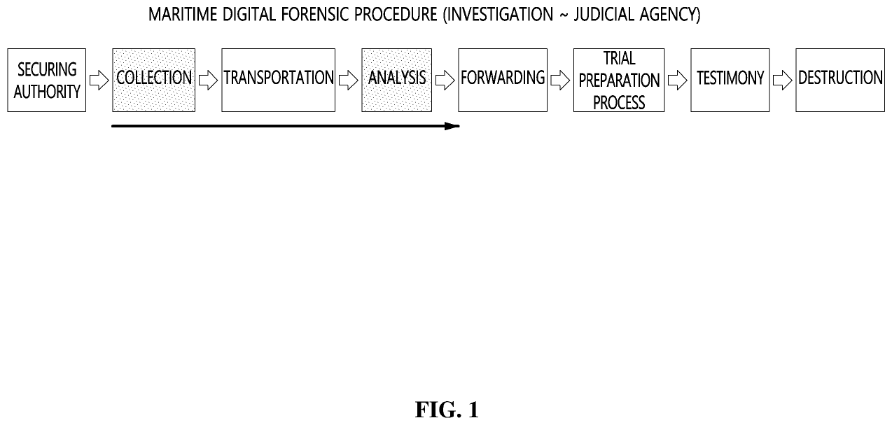

### DESCRIPTION OF THE PREFERRED EMBODIMENTS

The present disclosure will be described in detail below with reference to the accompanying drawings. Repeated descriptions and descriptions of known functions and configurations which have been deemed to unnecessarily obscure the gist of the present disclosure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated in order to make the description clearer.

Pieces of evidence collected at incident and accident scenes may include detailed evidential data and content about the incident and accident, and may include acquisition information about a legitimate method used for collecting each piece of evidential data.

So far, a system for managing an evidence package in the form of evidential data and acquisition data for evidence has not been provided. For example, maritime digital forensics is still in its early stages in the maritime sector, and there is no case of application of evidence package technology in the inland sector.

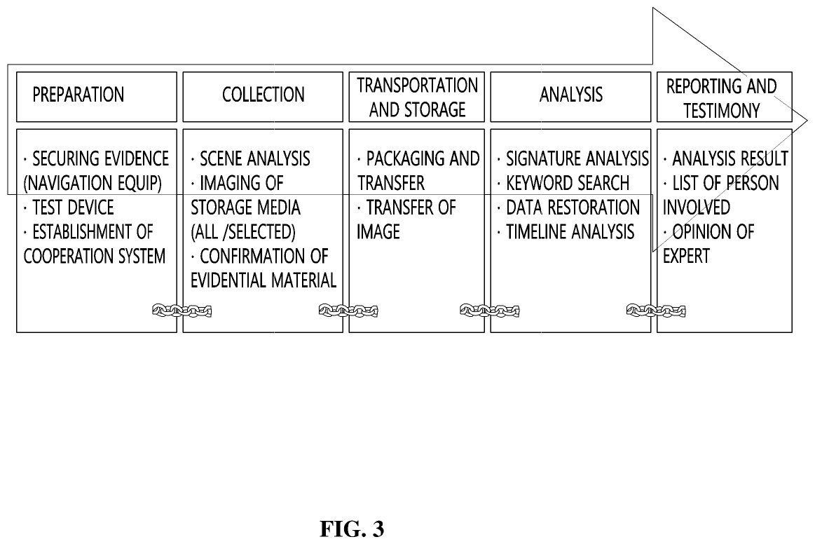

The present disclosure intends to propose a method for managing a structure in which an evidence package is generated in the form of a chain each time evidential data and relevant data are collected, as shown in FIG. 3, and in which history information and management information accumulated from an initial collection step are organized based on identifiers and provided when evidence is checked at a final reporting and testimony step.

Here, the evidence package generated in the form of a chain may be generated by identifying the respective management phases illustrated in FIG. 3, whereby details on successive transfers between entities storing evidential materials may be recorded along with an accurate history thereof in the processes of collecting, transporting, and analyzing digital evidence.

That is, the present disclosure intends to provide a systematic system in which the person who collects and handles evidence, a transfer process, details of processing, a storage method, a hash value, and the like are recorded in order to prove that digital evidence is managed without change in the original state, as it is collected.

For example, when it is applied to the maritime sector, track information stored in the memory of a navigation device installed in a small ship may be extracted. Based on the extracted GPS-based track information, operation trace metadata stored in the ship navigation device may be compared and combined with the ship wake data of the corresponding ship, which is stored in a land control system. Subsequently, the speed and time of the ship navigation may be calculated based on the combined information, and the accident situation, the time at which the accident is recognized, and the like are analyzed from each point of view and used as the evidence of the accident in order to analyze the cause of the accident. That is, an analysis method for maritime accidents of small ships and forensics therefor may be provided.

Particularly, the present disclosure corresponds to a forensic technology field for accident investigation, as technology that can be extended to fields other than maritime accidents, and may be extended to and used in all digital forensic fields in relation to circumstances in which an incident occurs and legal evidence is collected.

More particularly, original evidence directly collected at an incident scene is specified, and the process of generating a linkage hierarchical chain identifier for detecting the flow from acquisition of the original evidence to generation of final evidence without damage in or alteration to data may be provided in connection with the original evidence and various pieces of detailed evidence derived therefrom (additional evidence, collected evidence data, meta information on relevant records, identifiers, devices, and pieces of evidence collected in an analysis process after a transportation process). Also, based thereon, an integrated evidence package may be provided such that digital forensics can be performed for incidents and accidents.

That is, the present disclosure relates to technology for identifying evidence and systematically managing the identified evidence on principle.

Hereinafter, a preferred embodiment of the present disclosure will be described in detail with reference to the accompanying drawings.

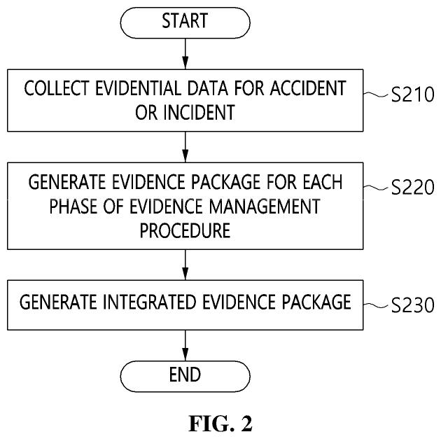

FIG. 2 is a flowchart illustrating a method for managing evidence based on packaging using a linkage hierarchical chain identifier according to an embodiment of the present disclosure.

Referring to FIG. 2, in the method for managing evidence based on packaging using a linkage hierarchical chain identifier according to an embodiment of the present disclosure, evidential data for an incident or an accident is collected at step S210.

Also, in the method for managing evidence based on packaging using a linkage hierarchical chain identifier according to an embodiment of the present disclosure, an evidence package is generated for each phase of an evidence management procedure based on a linkage hierarchical chain identifier, which is generated in consideration of collection of evidential data and an evidence-processing flow, at step S220.

Here, the linkage hierarchical chain identifier may be generated by linking an evidence collection identifier for identifying collection of evidential data and an evidence-processing identifier for identifying an evidence-processing flow.

Here, an evidence management procedure performed based on the evidence-processing identifier may correspond to a sequence of evidence collection, evidence sealing, evidence transportation, device analysis, incident analysis, and evidence integration.

Here, the evidence package may include the linkage hierarchical chain identifier, additional evidence and collected evidence data obtained by a task processed for each phase of the evidence management procedure, a hash value, information about the person who processes the task, log information, and additional information.

In the conventional method, only hash processing is performed in the processes of collecting, analyzing, and submitting evidential data, so a problem in which evidence is not systematically managed in an evidence acquisition process, and the like is caused. For example, the legal validity of evidential data is lost, or the evidentiary data is admitted merely as reference data.

In order to solve the above problems, the present disclosure generates a linkage hierarchical chain identifier in the process of collecting, transporting, and analyzing digital evidence and provides an evidence package in which details on successive transfers between entities storing evidence are recorded along with a history thereof in connection with the linkage hierarchical chain identifier.

That is, each time evidence is obtained, an evidence package is generated by packaging collected evidence information and additional information (the person who performs analysis, a transfer process, details of processing, a storage method, a hash value, and the like), whereby it may be proved that the digital evidence is managed without change in the original state, as it is first collected.

Here, collected evidence data may include image data collected based on evidential data and additional metadata.

Here, the evidence collection identifier is generated in a hierarchical structure from a broad to a narrow range in consideration of the range within which evidence is collected.

Here, the range within which evidence is collected may be classified in consideration of the source of a device from which evidence is collected, the device from which evidence is collected, and the type of evidence.

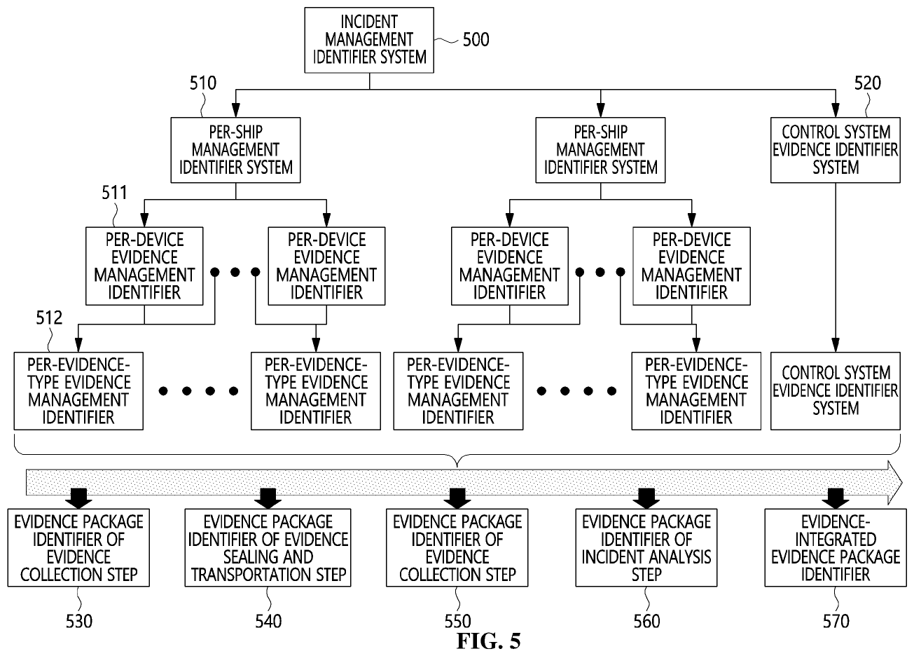

For example, FIG. 5 illustrates an example of an identifier system according to the present disclosure, and it can be seen that the identifier system is generated so as to separate and organize identifiers from an incident management identifier system 500 to identifier systems 510, 511 and 512, which have a hierarchical structure depending on the range within which evidence is collected.

Here, the example illustrated in FIG. 5 shows an identifier system for evidence collected form a maritime accident. Here, evidence may be identified in connection with ships, but may also be identified in a control system through a control system evidence identifier system 520.

Here, in order to simply manage evidential data, a system may be generated to generate identifiers in the form of serial numbers starting from 1 and to manage evidence using the identifiers. However, the present disclosure manages evidence by structurally combining the identifiers 530 to 570 depending on the procedure and range, e.g., the phase from the evidence is extracted, the ship from which the evidence is collected, the device in the ship from which the evidence is collected, the type of the evidence, and the like, as shown in FIG. 5, whereby the evidence may be easily identified and checked in the process of writing a final report and in the final integrated evidence package.

For example, referring to FIG. 5, an identifier managed by an integrated evidence package is generated to be increasingly detailed from a broad to a narrow range, that is, to have a form of (an incident management identifier—an identifier of a related ship or a control system—an evidence identifier for each device—an evidence identifier for each type), whereby pieces of data collected from a specific device may be identified and managed.

Here, the linkage hierarchical chain identifier may be identified for each incident by being matched to the incident management identifier corresponding to the incident or the accident.

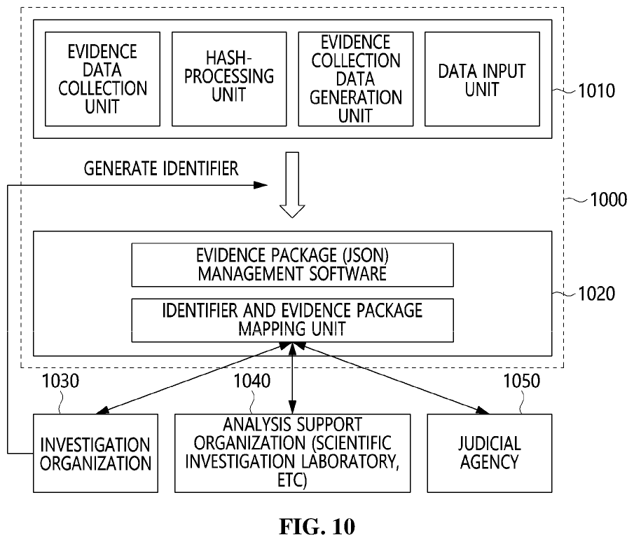

For example, FIG. 10 illustrates an example of a process of collecting and processing evidence according to the present disclosure, and illustrates the detailed configuration of an evidence package generation unit 1010 and an evidence package management unit 1020 in an evidence management apparatus 1000.

An evidence data collection unit may input evidential data that is collected in connection with an incident or an accident.

A hash-processing unit may generate a hash value for the evidential data input by the evidence data collection unit.

A collected evidence data generation unit may input data related to evidence collection in the process of collecting evidence.

A data input unit may input information about a person who collects evidential data, additional information related to evidence, a log, and the like.

Here, inputting collected evidence data and relevant data may be omitted according to need, and the evidence package generation unit 1010 may generate an evidence package by packaging the collected and input data.

Subsequently, the evidence management apparatus 1000 may generate a linkage hierarchical chain identifier and assign the same to the evidence package, and may manage the evidence package using the evidence package management unit 1020.

For example, an analysis support organization 1040 performs analysis using the evidence package, and when important evidential data for accident analysis is collected or found in the analysis process, the evidential data hashed based on evidence package management software and is then automatically included in a report as key evidence by generating an identifier therefor.

Here, a report may be written by mapping the incident management identifier to the linkage hierarchical chain identifier through an identifier and evidence package mapping unit, and the written report may be transferred to a judicial agency 1050 and used as legal evidence.

Here, in the evidence management procedure, integrity verification may be performed based on the hash value at steps after the evidence package is generated.

Also, in the method for managing evidence based on packaging using a linkage hierarchical chain identifier according to an embodiment of the present disclosure, an integrated evidence package including details on successive transfers according to the evidence management procedure is generated at step S230 based on the evidence package for each phase of the evidence management procedure.

Also, although not illustrated in FIG. 2, in the method for managing evidence based on packaging using a linkage hierarchical chain identifier according to an embodiment of the present disclosure, a report that is capable of being submitted as legal evidence for an incident or an accident is generated based on the integrated evidence package.

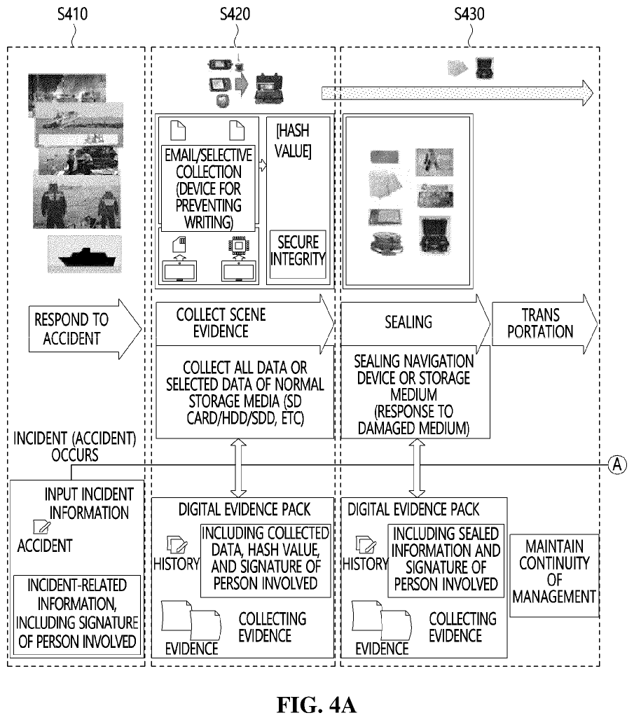

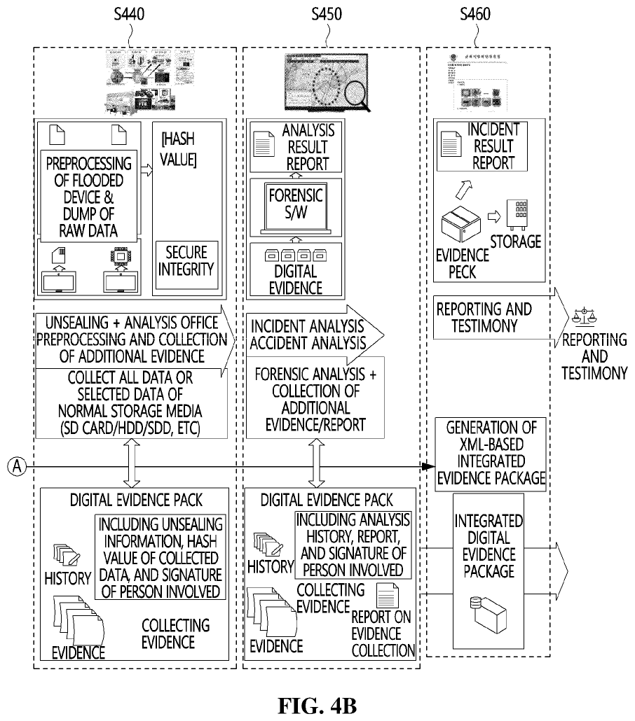

Hereinafter, a process for managing an evidence package will be described in detail with reference to FIG. 4A to 4B.

Here, FIG. 4A to 4B illustrates a process of managing an evidence package by taking a maritime accident as an example, and includes an analysis process through a briefing on the track of a ship after restoration of the track using data of a ship navigation device, a process of obtaining new evidence using the analyzed result and generating a report, and a process of generating an integrated evidence package to be submitted to a court.

First, at the incident occurrence step S410 illustrated in FIG. 4A, information about an incident may be generated, and an incident identifier may be generated.

Here, data and information about the incident may be input.

Subsequently, at the evidence collection step S420, coast guards called to the accident scene may check the ship in the accident, a device installed in the ship, and the like and collect pieces of evidence related to the accident.

Here, a ship identifier indicating the name of the ship is generated based on the location at which the evidence is collected, and a specific navigation device installed in the ship is identified.

For example, an imaging device for preventing the collected original data, such as an SD card, from being damaged may be used at the evidence collection step S420. That is, an identifier is generated and linked in the collection phase of a processing flow, and a scene evidence package having an identifier may be generated using scene evidence collected from a device. Here, hashed data for integrity verification, collected evidence information, log information, and additional information are also recorded, and recorder information such as the signature of the person involved may also be input.

Subsequently, at the collected evidential data sealing and transporting step S430, the sealing process or the process of sealing a storage medium may be managed as a history, and in this process, collected evidence data is stored together, whereby an evidence package may be generated.

Subsequently, the transported device may be unsealed and integrity verification may be performed at the device analysis step S440 illustrated in FIG. 4B. Here, integrity may be maintained if data is transported normally.

When it is confirmed at step S440 that integrity is maintained, data collected from each device may be analyzed. Here, preprocessing may be required depending on the device. For example, a device transported from a flooded ship may be analyzed after a cleaning and drying process is performed thereon.

Here, the track data of the ship in the accident may be acquired through analysis on dumped data, such as raw data dumped from a storage medium. When the acquired track data and device data related to the state of the ship are restored, the process of recording the same in an evidence package as new key evidence is required.

When the device analysis step S440 is completed, collecting evidence from all of the devices in the ship is completed.

Subsequently, the situation between the ship in the accident and other ships or between the ship in the accident and surroundings is analyzed through the incident analysis step S450, whereby the cause of the incident may be detected.

For example, in the case of a ship collision accident, the situation in which the incident occurred may be analyzed through a simulation using the track of the ship in the accident and the tracks of other ships.

In another example, in the case of a maritime accident, stranded objects, floatage, light buoys, other ships, sea states, the wind speed and direction, a sea fog, and the like may be analyzed.

Here, when the analysis result matches the accurately recorded information or testimony, the analysis result may be generated as evidence.

For example, among the pieces of data recorded at the previous steps, data and materials applied to the generation of the evidence may be recorded in detail as a history, and the simulation result is included in the form of video or a captured image, whereby an evidence package may be generated. Here, integrity may be provided through hash-processing also in the process of step S450.

Subsequently, the evidence integration step S460 is the process of generating a total evidence package for the accident, and the evidence packages for the respective phases of the evidence management procedure, which are generated through steps S410 to S450, are integrated based on JSON, whereby an integrated evidence package may be generated.

The integrated evidence package generated as described above may be included in the report to be submitted as legal evidence.

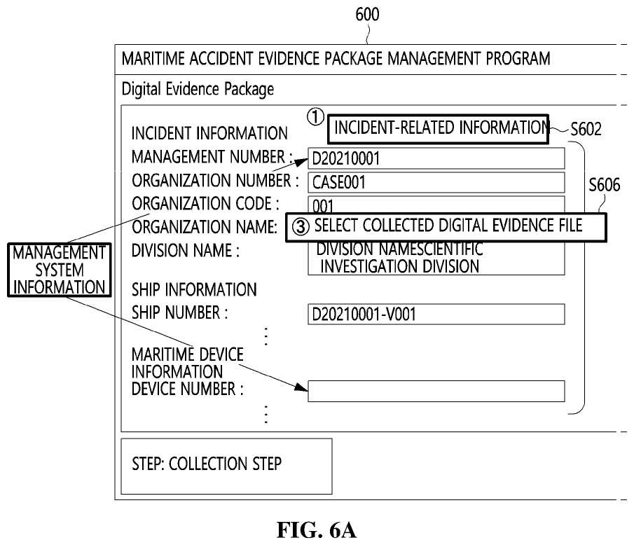

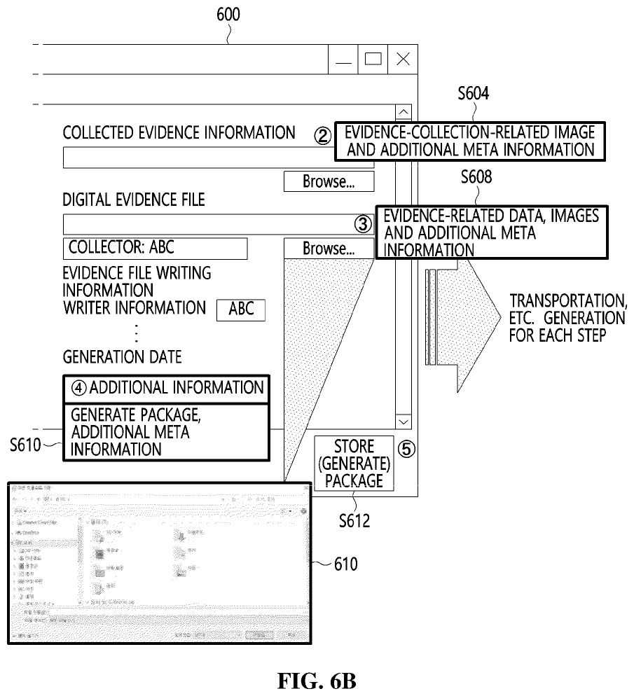

Hereinafter, a process of generating an evidence package and submitting legal evidence based on the generated evidence package will be described in detail with reference to FIGS. 6A to 8.

The present disclosure provides the maritime accident evidence package management program 600 illustrated in FIGS. 6A to 6B, thereby enabling management system information to be input when incident information about a maritime accident is generated.

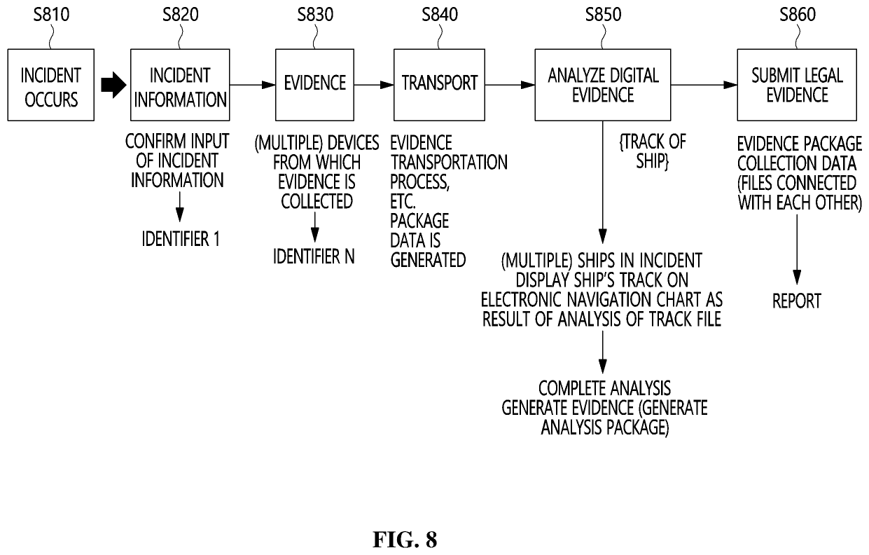

For example, assuming that a maritime accident occurs, an incident information input step S820 may be performed after the incident occurrence step S810 in FIG. 8. Here, the maritime accident evidence package management program 600 such as that illustrated in FIGS. 6A to 6B may be provided to an administrator. When all of incident-related information, images related to evidence collection and additional meta information, evidence-related data, additional information, and the like are input through steps S602 to S610 illustrated in FIGS. 6A to 6B, an identifier is generated through a package generation and storage step S612, and an evidence package to which the generated identifier is applied may be generated and stored in storage space 610. This process may correspond to the evidence package generation step S830 in FIG. 8.

Here, when data is input through the maritime accident evidence package management program 600, hashed data, that is, a hash value may also be input together with the data.

Subsequently, after the transportation step S840 illustrated in FIG. 8, evidence packages for respective phases of the evidence management procedure may be generated in a manner similar to that described with reference to FIGS. 6A to 6B.

Here, some steps may be omitted from the evidence management procedure depending on the circumstances. However, even though a step is omitted, the hierarchical identifier structure according to the evidence management procedure may be maintained, and the pieces of input evidence may be managed in the form of hierarchical data.

Subsequently, at the digital evidence analysis step S850 illustrated in FIG. 8, incident analysis and ship device analysis may be performed in an integrated manner. That is, the analysis process is performed in a chain of investigation laboratories, so an integrated evidence package may be generated by combining the evidence packages generated in previous steps, or evidence may be added. Therefore, the number of steps is not fixed.

Also, when evidence corresponding to a key factor of an incident or an accident or evidence for each step that has to be added to the report to be submitted as legal evidence is obtained at the digital evidence analysis step S850, the evidence may be automatically included in the report as the evidence of the corresponding step by changing the number of digits of the finally generated evidence generation identifier or by inputting a special tag.

When the analysis process is finally completed, new evidence is obtained from the analysis result, and this evidence may also be included in the package. The final evidence may be automatically included in the report as key evidence.

The final evidence package generated through the above-described process may be included in the report such that it is capable of being submitted as legal evidence through the legal evidence submission step S860.

Here, the evidence packages may be combined at the legal evidence submission step S860.

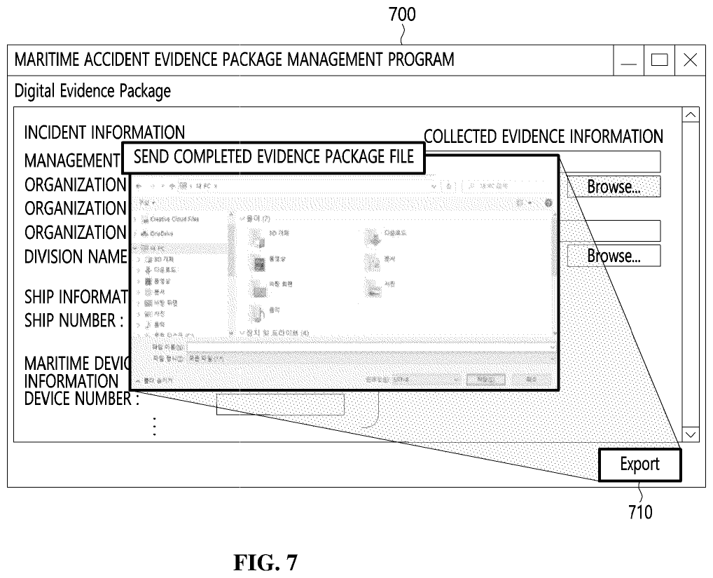

For example, the final evidence package may be generated as a unified file by selecting the export command 710 in the maritime accident evidence package management program 700 illustrated in FIG. 7.

The structure in which pieces of evidence related to an incident or an accident are integrated and managed as described above may be used in a court in order to prove that the evidence related to the incident or the accident is managed without any problem in the integrated system.

That is, if an evidence management process such as that proposed in the present disclosure is not applied, successive management of the collected evidence may not be provided, and a problem in which the validity of the legal evidence is lost may be caused.

According to the present disclosure, the possibility that a technical error occurs in the process of validating evidence of an important incident may be reduced, and pieces of evidential data may be intuitively detected using hierarchical identifiers. Also, because data related to all incidents and accidents may be easily extracted and analyzed systematically, there is an effect of saving the time consumed for analysis.

Through the above-described method for managing evidence based on packaging using a linkage hierarchical chain identifier, evidence collected from each phase and each element may be managed in compliance with regulations by which evidential data, which is digitized for validation of evidence collected in various incidents and accidents, is prevented from losing admissibility.

Also, a problem in which the legal validity of evidential data is lost in the processes of collecting, analyzing, and submitting the evidential data, may be prevented.

Also, whenever evidence is obtained, collected evidence information and additional information are organized in a package form and provided, whereby it may be proved that digital evidence is managed without any alteration to the original state, as it is first collected.

Also, when evidential data extracted from an incident or an accident is analyzed and a briefing thereon is presented, an evidence package for digital data, which is provided to a court after various processes such as evidence collection, transportation, and analysis, may be formed and managed.

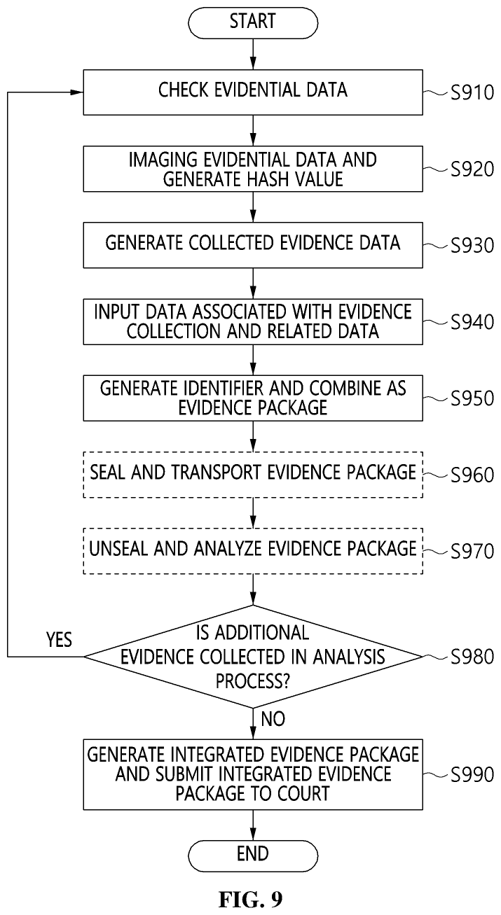

FIG. 9 is a flowchart illustrating in detail a process of generating an integrated evidence package and submitting the same to a court according to the present disclosure.

Referring to FIG. 9, in the process of generating an integrated evidence package and submitting the same to a court according to the present disclosure, first, when an incident or an accident occurs, collected evidential data may be checked at step S910.

Subsequently, the collected evidential data is stored using an imaging device such that the original data is prevented from being damaged, in which case a hash value for the evidential data may be generated and stored along with the evidential data at step S920.

Subsequently, collected evidence data is generated for the evidential data at step S930, data related to collection of evidence and relevant data are input at step S940, a linkage hierarchical chain identifier is generated by linking an evidence collection identifier and an evidence-processing identifier, and an evidence package including the input data may be generated based on the linkage hierarchical chain identifier at step S950.

The generated evidence package is sealed and transported to an analysis organization at step S960, and the analysis organization may unseal the transported evidence package and perform analysis at step S970.

Here, the processes of sealing and transporting the evidence package and unsealing the transported evidence package at steps S960 and S970 may be skipped depending on the evidence-processing environment.

Subsequently, whether additional evidence corresponding to a key factor of the accident is obtained or found in the analysis process is checked at step S980, and when additional evidence is obtained, the process from step S910 to step S970 may be performed for the additional evidence.

Also, when it is determined at step S980 that no additional evidence is obtained, an integrated evidence package is generated by combining all of the generated evidence packages, and a report including the integrated evidence package may be generated and submitted as legal evidence at step S990.

According to the above-described embodiment of the present disclosure, a problem in which an integrity management system is corrupted in a conventional forensic system due to difficulty in confirmation of continuity of evidential data management may be solved. That is, because data for validating evidence, collected evidence data, information about the person involved, and the like are systematically managed and checked across all of the processes including evidence collection and accident analysis, no problem is caused when such data is used as legal evidence.

Also, when a maritime accident occurs, accident-related data is analyzed by identifying various ships or a control system, whereby the cause of the accident may be analyzed and a similar accident may be prevented through a measure based on the analysis.

Also, when compared with the conventional technology in which neither a serial number nor an identifier is used, the possibility of a technical error may be reduced, and a problem related to the time taken to check and identify pieces of evidence may be solved.

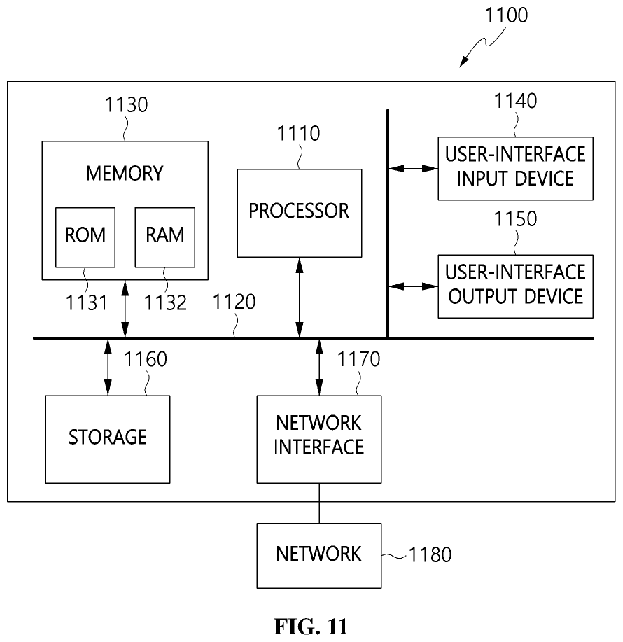

FIG. 11 is a view illustrating an example of an apparatus for managing evidence based on packaging using a linkage hierarchical chain identifier according to the present disclosure.

Referring to FIG. 11, the apparatus for managing evidence based on packaging using a linkage hierarchical chain identifier according to an embodiment of the present disclosure may be implemented in a computer system including a computer-readable recording medium. As illustrated in FIG. 11, the computer system 1100 may include one or more processors 1110, memory 1130, a user-interface input device 1140, a user-interface output device 1150, and storage 1160, which communicate with each other via a bus 1120. Also, the computer system 1100 may further include a network interface 1170 connected to a network 1180. The processor 1110 may be a central processing unit or a semiconductor device for executing processing instructions stored in the memory 1130 or the storage 1160. The memory 1130 and the storage 1160 may be any of various types of volatile or nonvolatile storage media. For example, the memory may include ROM 1131 or RAM 1132.

The processor 1110 collects evidential data for an incident or an accident.

Also, the processor 1110 generates an evidence package for each phase of an evidence management procedure based on a linkage hierarchical chain identifier generated in consideration of collection of evidential data and an evidence-processing flow.

Here, the linkage hierarchical chain identifier may be generated by linking an evidence collection identifier for identifying the collection of the evidential data and an evidence-processing identifier for identifying the evidence-processing flow.

Here, the evidence management procedure performed based on the evidence-processing identifier may correspond to a sequence of evidence collection, evidence sealing, evidence transportation, device analysis, incident analysis, and evidence integration.

Here, the evidence package may include the linkage hierarchical chain identifier, additional evidence and collected evidence data obtained by a task processed for each phase of the evidence management procedure, a hash value, information about the person who processes the task, log information, and additional information.

Here, the linkage hierarchical chain identifier may be classified for each incident by being matched to an incident management identifier corresponding to an incident or an accident.

Here, an evidence collection identifier is generated in a hierarchical structure from a broad to a narrow range in consideration of a range within which evidence is collected.

Here, the range within which evidence is collected may be classified in consideration of the source of a device from which evidence is collected, the device from which the evidence is collected, and the type of the evidence.

Here, collected evidence data may include image data collected based on evidential data and additional metadata.

Also, the processor 1110 generates an integrated evidence package including details on successive transfers according to the evidence management procedure based on the evidence packages for the respective phases of the evidence management procedure.

Also, the processor 1110 performs integrity verification based on a hash value at the steps performed after the evidence package is generated in the evidence management procedure.

Also, the processor 1110 generates a report capable of being submitted as legal evidence for an incident or an accident based on the integrated evidence package.

The memory 1130 stores the evidence package for each phase of the evidence management procedure and the integrated evidence package.

Accordingly, an embodiment of the present disclosure may be implemented as a non-transitory computer-readable storage medium in which methods implemented using a computer or instructions executable in a computer are recorded. When the computer-readable instructions are executed by a processor, the computer-readable instructions may perform a method according to at least one aspect of the present disclosure.

Using the above-described apparatus for managing evidence based on packaging using a linkage hierarchical chain identifier, evidence collected from each phase and each element may be managed in compliance with regulations by which evidential data, which is digitized for validation of evidence collected in various incidents and accidents, is prevented from losing admissibility.

Also, a problem in which the legal validity of evidential data is lost in the processes of collecting, analyzing, and submitting the evidential data, may be prevented.

Also, whenever evidence is obtained, collected evidence information and additional information are organized and provided in a package form, whereby it may be proved that digital evidence is managed without any alteration to the original state, as it is first collected.

Also, when evidential data extracted from an incident or an accident is analyzed and a briefing thereon is presented, an evidence package for digital data, which is provided to a court after various processes such as evidence collection, transportation, and analysis, may be formed and managed.

According to the present disclosure, there may be provided technology for managing evidence collected from each phase and each element while complying with regulations such that evidential data, which is digitized for validation of evidence collected in various incidents and accidents, is prevented from losing admissibility.

Also, the present disclosure may prevent a problem in which the legal validity of evidential data is lost in the processes of collecting, analyzing, and submitting the evidential data.

Also, the present disclosure organizes collected evidence information and additional information in a package form and provides the package each time evidence is obtained, thereby proving that digital evidence is managed without any alteration to the original state, as it is first collected.

Also, the present disclosure may provide a system for analyzing evidential data extracted from incidents and accidents and for forming and managing an evidence package with a JSON style file below for digital data to be submitted to a court after various processes, such as evidence collection, transportation, and analysis, when a briefing on the evidential data is provided.

```
JSON Format example :
{
“FORMAT”: “ETRI SAIDA CASE EVIDENCE”,
“MAKER”: “ETRI”,
“VERSION”: 2022,
“FILES”: [
{
“mgmt_id”: “D20220101A”,
  “Case_Info”: {
    “case_id”: “KICS2022-11250011”,
    “case_summary”: “2022.06.03 ship crashed”,
    “case_address”: “inchon ”,
    “case_datetime”: “2022-06-03T13:56+09:00”,
    “case_data_gathering_datetime”: “2022-06-05T14:16+09:00”
  },
  “Vessels”: [
    {
      “vessel mgmtjd”: “D20220101A-V001”,
      “vellel_id”: 1,
      “Vessel_Info”: {
        “vessel_name”: “Yeongjong-Ho”,
        “vessel_type”: “fishing boat”,
        “vessel_tonnage”: “10”,
        “vessel_length”: “10”
      }
“Equipments”: [
        {
          “mgmt_id”: “D20220101A-V001 -E001-D000”.
          “vessel_id”: 1,
          “equipment_id”: 1,
          “equipment_info”: {
            “type”: “GPS Plotter”,
            “manufacturer”: “samsung”,
            “model”: “NF100A”,
            “serial”: “12345”,
            “description”: “in ship ”,
            “note”: “no time delay with GPS”
          }
        },
{
          “mgmt_id”: “D20220101A-V001-E002-D000”.
            “vessel_id”: 1,
            “equipment_id”: 2,
            “equipment_info”: {
              “type”: “GPS Plotter”,
              “manufacturer”: “rolence”,
              “model”: “HDS7”,
              “serial”: “12345”,
              “description”: “in ship”,
              “note”: “no time delay with GPS ”
            }
          },
“Imagings”: [
          {
            “gathering_type”: “MICRO_SD”,
            “mgmt_id”: “D20220101A-V001-E001-D001”
            “vessel_id”: 1,
            “equipment_id”: 1,
            “file_name”: “cfreds_2015_data_leakage_rm11.E01”,
            “file_path”: “2022/D20220101A/VesselData/V001/E001”
            “file_hash_type”: “SHA1”,
            “file_hash_value”:
“8fed289c345cc0d048432b6d8ff11d049de34cc”
          }
```

As described above, the apparatus for managing evidence based on packaging using a linkage hierarchical chain identifier and the method using the same according to the present disclosure are not limitedly applied to the configurations and operations of the above-described embodiments, but all or some of the embodiments may be selectively combined and configured, so the embodiments may be modified in various ways.

What is claimed is:

1. A method for managing evidence, comprising:
collecting evidential data for an incident or an accident;
generating an evidence package for each phase of an evidence management procedure based on a linkage hierarchical chain identifier generated in consideration of collection of the evidential data and an evidence-processing flow; and
generating an integrated evidence package, including details on successive transfers according to the evidence management procedure, based on the evidence package for each phase of the evidence management procedure.

2. The method of claim 1, wherein the linkage hierarchical chain identifier is generated by linking an evidence collection identifier for identifying the collection of the evidential data and an evidence-processing identifier for identifying the evidence-processing flow.

3. The method of claim 2, wherein the evidence management procedure performed based on the evidence-processing identifier corresponds to a sequence of evidence collection, evidence sealing, evidence transportation, device analysis, incident analysis, and evidence integration.

4. The method of claim 3, wherein the evidence package includes the linkage hierarchical chain identifier, additional evidence and collected evidence data obtained by a task processed for each phase of the evidence management procedure, a hash value, information about a person who processes the task, log information, and additional information.

5. The method of claim 1, wherein the linkage hierarchical chain identifier is classified for each incident by being matched to an incident management identifier corresponding to the incident or the accident.

6. The method of claim 2, wherein the evidence collection identifier is generated in a hierarchical structure from a broad to a narrow range in consideration of a range within which evidence is collected.

7. The method of claim 6, wherein the range within which evidence is collected is classified in consideration of a source of a device from which the evidence is collected, the device from which the evidence is collected, and a type of the evidence.

8. The method of claim 4, wherein integrity verification is performed based on the hash value in phases performed after the evidence package is generated in the evidence management procedure.

9. The method of claim 1, further comprising:
based on the integrated evidence package, generating a report capable of being submitted as legal evidence for the incident or the accident.

10. The method of claim 4, wherein the collected evidence data includes additional metadata and image data collected based on the evidential data.

11. An apparatus for managing evidence, comprising:
a processor for collecting evidential data for an incident or an accident, generating an evidence package for each phase of an evidence management procedure based on a linkage hierarchical chain identifier generated in consideration of collection of the evidential data and an evidence-processing flow, and generating an integrated evidence package, which includes details on successive transfers according to the evidence management procedure, based on the evidence package for each phase of the evidence management procedure; and
memory for storing the evidence package for each phase of the evidence management procedure and the integrated evidence package.

12. The apparatus of claim 11, wherein the linkage hierarchical chain identifier is generated by linking an evidence collection identifier for identifying the collection of the evidential data and an evidence-processing identifier for identifying the evidence-processing flow.

13. The apparatus of claim 12, wherein the evidence management procedure performed using the evidence-processing identifier corresponds to a sequence of evidence collection, evidence sealing, evidence transportation, device analysis, incident analysis, and evidence integration.

14. The apparatus of claim 13, wherein the evidence package includes the linkage hierarchical chain identifier, additional evidence and collected evidence data obtained by a task processed for each phase of the evidence management procedure, a hash value, information about a person who processes the task, log information, and additional information.

15. The apparatus of claim 11, wherein the linkage hierarchical chain identifier is classified for each incident by being matched to an incident management identifier corresponding to the incident or the accident.

16. The apparatus of claim 12, wherein the evidence collection identifier is generated in a hierarchical structure from a broad to a narrow range in consideration of a range within which evidence is collected.

17. The apparatus of claim 16, wherein the range within which evidence is collected is classified in consideration of a source of a device from which the evidence is collected, the device from which the evidence is collected, and a type of the evidence.

18. The apparatus of claim 14, wherein integrity verification is performed based on the hash value in phases performed after the evidence package is generated in the evidence management procedure.

19. The apparatus of claim 11, wherein the processor generates a report capable of being submitted as legal evidence for the incident or the accident based on the integrated evidence package.

20. The apparatus of claim 14, wherein the collected evidence data includes additional metadata and image data collected based on the evidential data.
